(19) United States
(12) Patent Application Publication
(10) Pub. No.: US 2006/0179214 A1
(43) Pub. Date: Aug. 10, 2006

(54) External storage control device and program for the same

(75) Inventor: Shigeto Kitamura, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/079,047

(22) Filed: Mar. 14, 2005

(30) Foreign Application Priority Data
Dec. 28, 2004 (JP) 2004-380771

(51) Int. Cl. G06F 13/00

(52) U.S. Cl. 711/111

(57) ABSTRACT

An external storage control device HDC which receives a command from a host system and transfers data to and from an external storage device, comprises: a latch section which stores data received from the host system for writing to a task file register in the HDC, when in a normal power mode during which a clock is supplied from an oscillator to the HDC; a latch section which stores data for writing to the task file register, when in a power-saving mode during which the clock from the oscillator is not supplied to the HDC; and a selecting section MUX which selects the data to be written to the task file register in such a manner that, in the normal power mode, the data stored in the former latch section is written to the task file register and, in the power-saving mode, the data stored in the latter latch section is written to the task file register. With this configuration, power consumption is reduced by stopping the internal clock during the standby mode.

### CROSS-REFERENCE TO RELATED APPLICATION

This application claims priority from, and incorporates by reference the entire disclosure of, Japanese Patent Application (1) No. 2004-380771 which was filed on Dec. 28, 2004.

### BACKGROUND OF THE INVENTION

1. Field of the Invention

The present invention relates to an external storage control device and a program for the same, and more particularly to an external storage control device wherein provisions are made to reduce the power consumption of a hard disk controller (HDC) while permitting the reception of an ATA command from a host system such as a host computer, and a program for the same.

2. Description of the Related Art

In the prior art, a variety of technologies for reducing the power consumption of electronic devices have been proposed and implemented. For example, the prior art discloses a technology for reducing the power consumption of a CMOS circuit or the like in a personal computer (Patent Document 1).

To reduce the power consumption of a CMOS circuit or the like, the personal computer described in Patent Document 1 operates such that, when in an idle state such as a state waiting for a key input, a start/stop command for an oscillator circuit is received from the system and the command is written to a control register; here, when the stop command is received from the system, the supply of an oscillator signal is stopped, by means of a gate circuit, in synchronism with the memory cycle, and when the start command for resuming the supply of the oscillator signal is received from the system, the supply of the oscillator signal is resumed by means of the gate circuit, and an operation such as a memory access is initiated after a prescribed time has elapsed. The personal computer described in Patent Document 1 does not stop the operation of the oscillator circuit itself.

There is also disclosed in the prior art a technology for reducing the power consumption of an external storage device, including a nonvolatile memory such as a flash memory, that transfers data to and from a host computer (Patent Document 2).

To achieve low power consumption as well as a speedup of sector data write access, the external storage device 1 described in Patent Document 2 operates such that, when the clock oscillation of an oscillation device 18 is stopped, a data write request from the host computer 2 is received at a host interface section 11 and, when the data write request is received at the host interface section 11, a sector buffer control section 13 causes the data transferred from the host computer 2 to be held in a sector buffer A or B in accordance with a write signal from the host computer 2. On the other hand, when the data write request is received at the host interface section 11, a clock oscillation control section 17 instructs the oscillation device 18 to resume the clock oscillation. After the clock in the oscillation device 18 has stabilized, a microprocessor 12 performs control to transfer the data held in the sector buffer A or B to a flash memory array 19, as an external storage device, so that the external storage device can quickly respond to a sector data write command issued from the host computer 2 even when the clock oscillation is stopped.

The external storage device 1 described in Patent Document 2 transfers data to and from the host computer 2; that is, when the clock oscillation of the oscillation device 18 is stopped, the host interface section 11 receives a data write request from the host computer 2, and the host interface control section 11 generates a clock pulse so that the data output from the host computer 2 is latched into the sector buffer A or B by the rising or falling edge of the thus generated clock pulse in accordance with the write signal from the host computer 2. However, in the external storage device 1 described in Patent Document 2, the frequency of the clock pulse generated and used when the clock oscillation of the oscillation device 18 is stopped is not high enough to be used for high-speed data transfer such as ultra DMA (Ultra Direct Memory Access) required of a hard disk controller (HDC). Ultra DMA requires the use of a high-frequency clock and achieves high data transfer rate by using both the rising and falling edges of the clock pulse. Next, a description will be given of an HDC of which ultra DMA is required that requires the use of a high-frequency clock.

FIG. 5 is a block diagram showing the configuration of a hard disk controller according to the prior art, and FIG. 6 is a circuit diagram illustrating the details of a task file latch circuit shown in FIG. 5. As shown in FIG. 5, the hard disk controller (HDC) 101 is connected to a CPU board (not shown) in a host computer 102; here, the HDC 101 is built into a hard disk drive (HDD) 101A together with an external oscillator 111. The HDC 101 includes a microprocessor (MPU) 110, a clock generating circuit 113, and a phase-locked loop (PLL) 112 which receives a clock signal from the oscillator 111 and supplies a signal precisely locked in frequency to the clock generating circuit 113. The clock generating circuit 113 receives the output of the PLL 112 and generates clock pulses which are supplied to the MPU 110 and an interface (I/F) control circuit 120 and also to an interface (I/F) block containing a task file latch 130.

In FIG. 6, FF stands for flip-flop, and FF-0 to FF-7 designate eight FFs which together latch eight-bit data. In the prior art, information transferred from the host computer 102 is stored in a task file register within the I/F control circuit 120 in synchronism with an internal clock, i.e., the clock generated via the oscillator 111, the PLL 112, and the clock generating circuit 113. Accordingly, as shown in FIG. 6, when the internal clock is stopped, if an ATA command (for example, a write command DIOW or a read command DIOR) is issued from the host computer 102, the command cannot be received because the eight-bit data (DD) transferred from the host computer 102, which needs to be stored in the task file register to receive the command, cannot be temporarily stored in FF-0 to FF-7. As a result, in an ATA standby mode during which a command may be issued, it has not been possible to stop the internal clock and, hence, it has been impossible to reduce the power consumption of the HDC 101 in a standby mode. Here, other than DIOW and DIOR, the ATA commands include CS0, CS1, DA0, DA1, and DA2 for specifying one of the seven registers in the I/F control circuit 120.

FIG. 7 is a flowchart illustrating a standby process according to the prior art, and FIG. 8 is a flowchart illustrating a sleep process according to the prior art. In the standby process of the prior art shown in FIG. 7, as the I/F control clock cannot be stopped, the MPU clock is switched to the output of the oscillator 111 and the PLL is disabled; then, the process waits for a wakeup. On the other hand, in the sleep process of the prior art shown in FIG. 8, as there is no need to store command information, the I/F control clock can be stopped; therefore, the I/F control clock is stopped, and the oscillator 111 as well as the PLL 112 is disabled.

In the flowchart shown in FIG. 7, in step 701 the oscillator 111 is selected as the source for the clock signal to the MPU 110. In step 702, the PLL 112 is disabled. In step 703, a decision is made as to whether the power supply mode is the wakeup mode or not (the power-saving mode) and, if the result of the decision is YES, the process proceeds to step 704; if the result of the decision is NO, the process returns to step 703. In step 704, the PLL 112 is enabled, and the standby process is thus terminated.

In the flowchart shown in FIG. 8, the power-down bit is set in step 801. In step 802, the I/F control clock is stopped. In step 803, the oscillator 111 is selected as the source for the clock signal to the MPU 110. In step 804, the PLL 112 is disabled. In step 805, the oscillator 111 is disabled.

In step 806, a decision is made as to whether the power supply is to be put in the power-saving mode or the wakeup mode and, if the result of the decision is the wakeup mode, the process proceeds to step 807; on the other hand, if the result of the decision is the power-saving mode, the process returns to step 806.

In step 807, the oscillator is enabled.

In step 808, the PLL 112 is enabled. In step 809, the PLL 112 is selected as the source for the I/F control clock and also the source for the clock signal to the MPU 110. In step 810, the power down bit is reset, and the sleep process is thus terminated.

[Patent Document 1] Japanese Unexamined Patent Publication No. H04-134509. Line 11 in upper left column to line 15 in upper right column on page 2, and FIG. 1 in Drawings.

[Patent Document 2] Japanese Unexamined Patent Publication No. H10-283768. Claim 1, Paragraphs [0003], [0008], [0011], [0020], [0025], [0027], and [0037], and [FIG. 1] and [FIG. 2] in Drawings.

In the prior art configuration, once the internal clock is stopped, if an ATA command is issued, the command cannot be received because the information necessary for receiving the command cannot be stored; therefore, in the ATA standby mode during which a command may be issued, the internal clock cannot be stopped, thus resulting in the problem that the power consumption is high.

### SUMMARY OF THE INVENTION

It is therefore an object of the present invention to solve the above problem and provide an external storage control device that allows the internal clock to be stopped, even in a standby mode, and thereby achieve a saving in power consumption, and a program to be used for the same.

According to a first mode of the invention that achieves the above object, an external storage control device which receives a command from a host system and transfers data to and from an external storage device, comprises: a detecting section which detects a write command for writing data from the host system to a task file register in the external storage control device, when in a power-saving mode during which a clock from an oscillator is not supplied to the external storage control device; and a latch section which stores the data in synchronism with the write command.

According to a second mode of the invention that achieves the above object, an external storage control device which receives a command from a host system and transfers data to and from an external storage device, comprises: a first latch section which stores data received from the host system for writing to a task file register in the external storage control device when in a normal power mode during which a clock from an oscillator is supplied to the external storage control device; a second latch section which stores data received from the host system for writing to the task file register in the external storage control device when in a power-saving mode during which the clock from the oscillator is not supplied to the external storage control device; and a selecting section which selects the data to be written to the task file register in such a manner that, in the normal power mode, the data stored in the first latch section is written to the task file register and, in the power-saving mode, the data stored in the second latch section is written to the task file register.

The external storage control device further comprises a signal generating section which generates a signal for causing the data stored during the power-saving mode to be written to the task file register when clock operation is resumed by switching from the power-saving mode during which the clock from the oscillator is not supplied to the external storage control device back to the normal power mode during which the clock from the oscillator is supplied to the external storage control device.

In the external storage control device, the data stored during the power-saving mode is written to the task file register when the output signal of the signal generating section is inverted.

A program, provided for use in the external storage control device of the invention which achieves the above object and which receives a command from a host system and transfers data to and from an external storage device, causes a computer to execute the steps of: setting a power down bit for switching from a normal power mode during which a clock is supplied from an oscillator to the external storage control device to a power-saving mode during which the clock is not supplied; stopping the supply of the clock from the oscillator to the external storage control device when the power down bit is set; when switching is made from the power-saving mode back to the normal power mode, then resetting the power down bit and writing, to a task file register in the external storage control device, data that has been transferred from the host system for writing to the task file register and that has been held in a latch section while the supply of the clock to the external storage control device is stopped; and resuming the supply of the clock from the oscillator to the external storage control device when switching has been made from the power-saving mode back to the normal power mode.

The present invention concerns an external control storage device for receiving an ATA command when the internal clock is stopped, wherein switching is done from one circuit to another according to whether the clock is in an operating condition or a stopped condition so that, in either case, the value to be written to the task file register can be saved.

By applying the present invention, it becomes possible to stop the internal clock even in the ATA standby mode during which a command may be issued, and thus the power consumption in the ATA standby mode can be reduced. Further, as the write information to the task file register, which has been saved during the stoppage of the clock, is copied upon resumption of the clock operation to the task file register used by firmware, the same register can be used as the register that the firmware refers to when analyzing the command, and a commonality of firmware operation can thus be achieved.

### BRIEF DESCRIPTION OF THE DRAWINGS

FIG. 1 is a block diagram showing the configuration of a hard disk controller according to the present invention;

FIG. 2 is a circuit diagram illustrating the details of a task file latch circuit shown in FIG. 1;

FIG. 3 is a circuit diagram illustrating the details of an I/F control circuit shown in FIG. 1;

FIG. 4 is a flowchart illustrating a standby process according to the present invention;

FIG. 5 is a block diagram showing the configuration of a hard disk controller according to the prior art;

FIG. 6 is a circuit diagram illustrating the details of a task file latch circuit shown in FIG. 5;

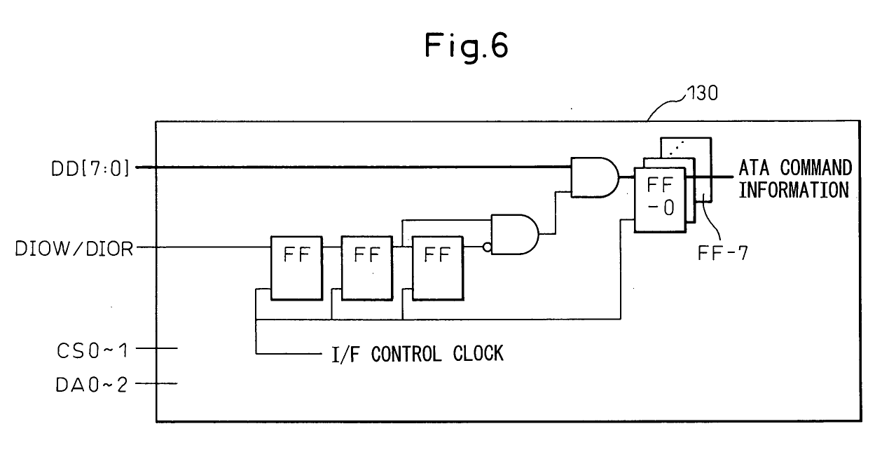

FIG. 7 is a flowchart illustrating a standby process according to the prior art; and

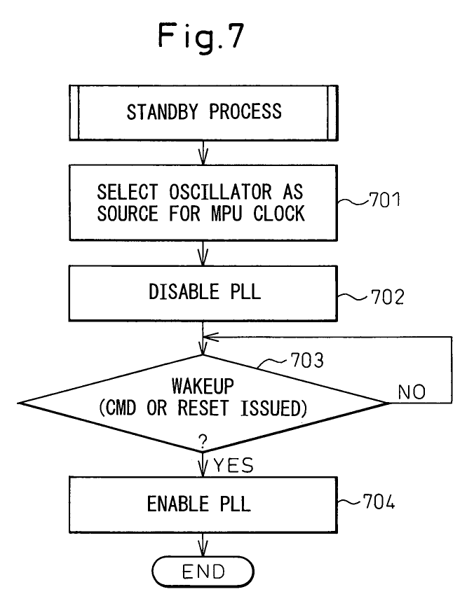

FIG. 8 is a flowchart illustrating a sleep process according to the prior art.

### DESCRIPTION OF THE PREFERRED EMBODIMENTS

An embodiment of the present invention will be described in detail below with reference to the accompanying drawings.

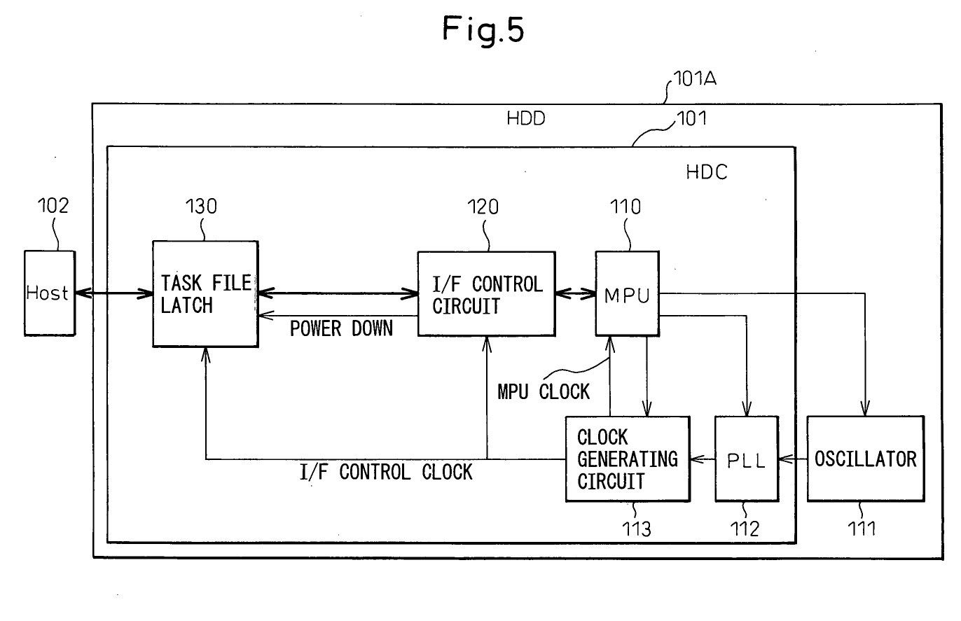

As previously described with reference to FIG. 5, in the hard disk controller 101 according to the prior art, any command issued by the host computer 102 is latched by the I/F block 130 in synchronism with the I/F control clock, and the latched information is passed to the I/F control circuit 120. Accordingly, if the I/F control clock is stopped, the command from the host computer 102 cannot be latched.

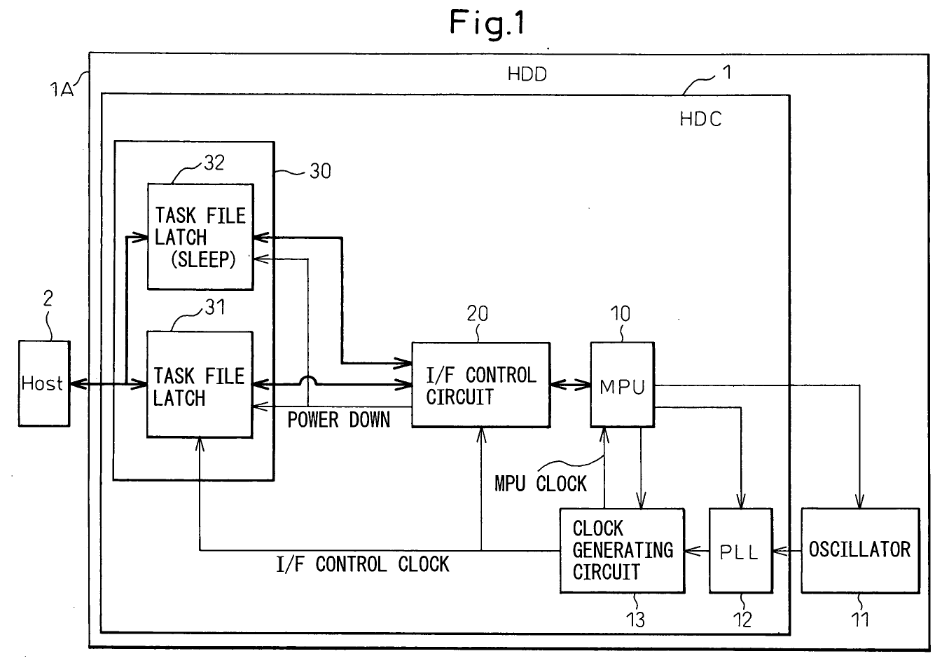

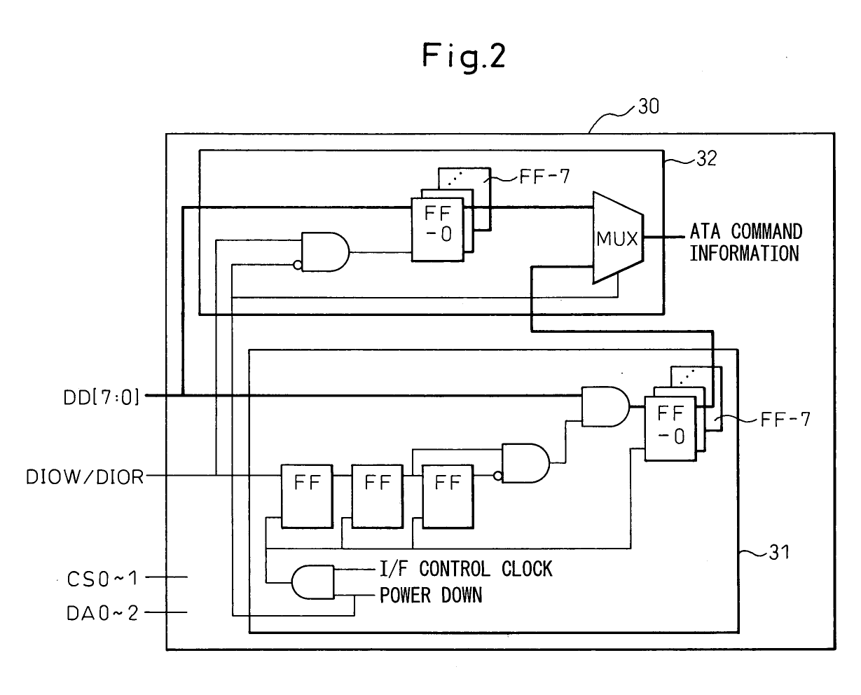

The embodiment of the present invention described hereinafter deals with an example in which the host computer is a personal computer, but the host computer is not limited to the personal computer; for example, some other system communicating with an HDD may be used instead. FIG. 1 is a block diagram showing the configuration of a hard disk controller according to the present invention, and FIG. 2 is a circuit diagram illustrating the details of a task file latch circuit shown in FIG. 1. As shown in FIG. 1, the hard disk controller (HDC) 1 is connected to a CPU board (not shown) in a host computer 2; here, the HDC 1 is built into a hard disk drive (HDD) 1A together with an external oscillator 11. The HDC 1 includes a microprocessor (MPU) 10, a clock generating circuit 13, and a phase-locked loop (PLL) 12 which receives a clock signal from the oscillator 11 and supplies a signal of precisely locked frequency to the clock generating circuit 13. The clock generating circuit 13 receives the output of the PLL 12 and generates clock pulses which are supplied to the MPU 10 and an interface (I/F) control circuit 20 and also to a task file latch 31 in an interface (I/F) block 30.

The hard disk controller HDC 1 is built into the hard disk drive (HDD) 1A. Though not shown here, the hard disk in the HDD 1A comprises a disk or disks of aluminum or glass coated with a magnetic material. In the HDD 1A, the disk is being rotated at high speed by a motor, and data is read from or written to the disk by bringing a magnetic head into close proximity to the disk.

As shown in FIG. 1, in the present invention, whether to latch data by the normal mode task file latch 31 in the interface (I/F) block 30 in synchronism with the I/F control clock or to latch data by a sleep mode task file latch 32 in the I/F block 30 in synchronism with a strobe input from the host computer 2 can be selected based on the power down signal shown in FIG. 2, which is an output signal of the I/F control circuit 20. Further, the data held in the sleep mode task file latch 32 as well as the data held in the normal mode task file latch 31 in the I/F block 30 can be copied; that is, when the power down signal is cleared, the data in the sleep mode task file latch 32 is automatically copied to a task file register in the I/F control circuit 20, and the MPU 10 can thus acquire the command information from the same task file register in the I/F control circuit 20.

The MPU 10 executes the following program stored in a ROM or a battery-powered RAM provided within the HDC 1. That is, the program provided for use in the external storage control device (HDC) 1 which receives a command from the host computer 2 and transfers data to and from the external storage device, causes the MPU 10 to execute the steps of: setting a power down bit for switching from a normal power mode during which a clock is supplied from the oscillator 11 to the external storage control device 1 to a power-saving mode during which the clock is not supplied; stopping the supply of the clock from the oscillator 11 to the external storage control device 1 when the power down bit is set; when switching is made from the power-saving mode back to the normal power mode, then resetting the power down bit and writing, to the task file register in the external storage control device 1, the data that has been transferred from the host computer 2 for writing to the task file register and that has been held in the latch circuit 32 while the supply of the clock to the external storage control device 1 is stopped; and resuming the supply of the clock from the oscillator 11 to the external storage control device 1 when switching has been made from the power-saving mode back to the normal power mode.

In FIG. 2, FF stands for flip-flop, and FF-0 to FF-7 designate eight FFs which together latch eight-bit data. Of the two task file latch circuits (synchronize-DIOW/DIOR) 31, 32 shown in FIG. 2, the task latch circuit 32 is the circuit additionally provided according to the present invention; when the I/F control (internal) clock is operating, the usual task file latch circuit 31 is used, and when the internal clock is stopped, switching is made to the task file latch circuit 32 in response to the power down signal, so that whether the internal clock is operating or is being stopped, the information to be written to the task file register can be saved, thus making it possible to receive the command even when the internal clock is stopped. Further, by using the edge occurring when the power down signal is cleared, the task file register information saved during the stoppage of the clock is selected by a multiplexer (MUX) and written to the task file register to be used by firmware.

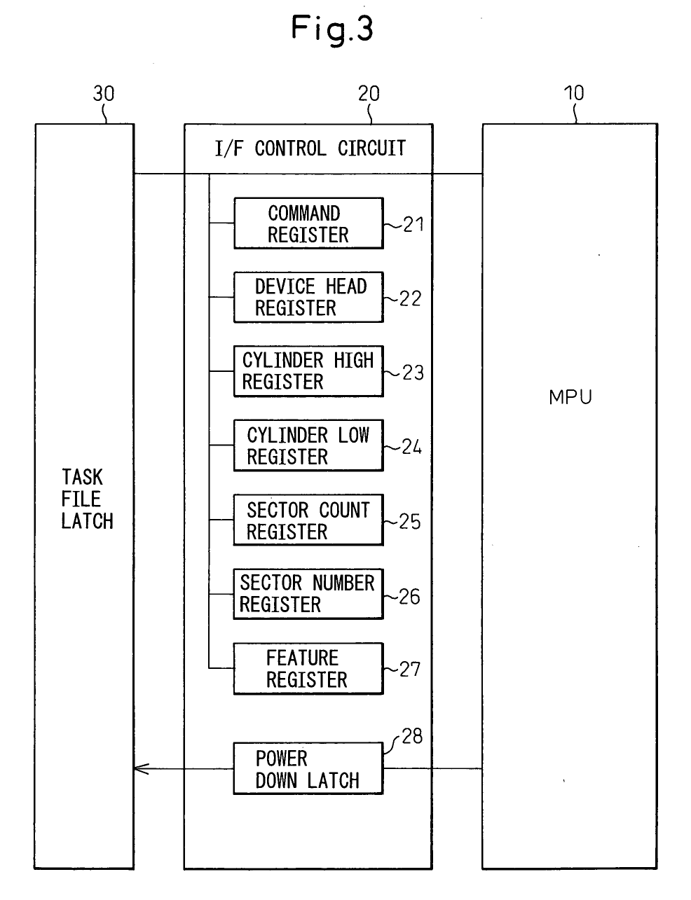

FIG. 3 is a circuit diagram illustrating the details of the I/F control circuit shown in FIG. 1. As shown in FIG. 3, in the I/F control circuit 20, seven registers necessary for reading and writing data on the hard disk are connected via a bus line connecting between the task file latch 30 and the MPU 10. ATA command data transferred from the task file latch 30 are stored in these registers and sent to the MPU 10. The seven registers are collectively called the task file register, and include a command register 21, a device head register 22, a cylinder high register 23, a cylinder low register 24, a sector count register 25, a sector number register 26, and a feature register 27. The command register 21 stores ATA command read/write data, the device head register 22 stores information about the device and head, the cylinder high register 23 and the cylinder low register 24 store cylinder position information, the sector count register 25 stores information indicating how many sectors from the specified sector position are to be read or written, the sector number register 26 stores sector position information, and the feature register 27 stores information indicating the kind of the command.

The MPU 10 reads the information stored in the command register 21 and performs a read or write operation to the hard disk according to the readout command by using the information stored in the other registers 22 to 27. The I/F control circuit 20 further contains a power down latch 28 for latching the power down signal being sent from the MPU 10 to the task file latch 30. When the bit of the power down latch 28 is, for example, a 0, the power supply mode is the normal power mode, so that the clock from the oscillator 11 is supplied to the HDC 1; on the other hand, when this bit is a 1, the power supply mode is the power-saving mode, so that the clock from the oscillator 11 is not supplied to the HDC 1.

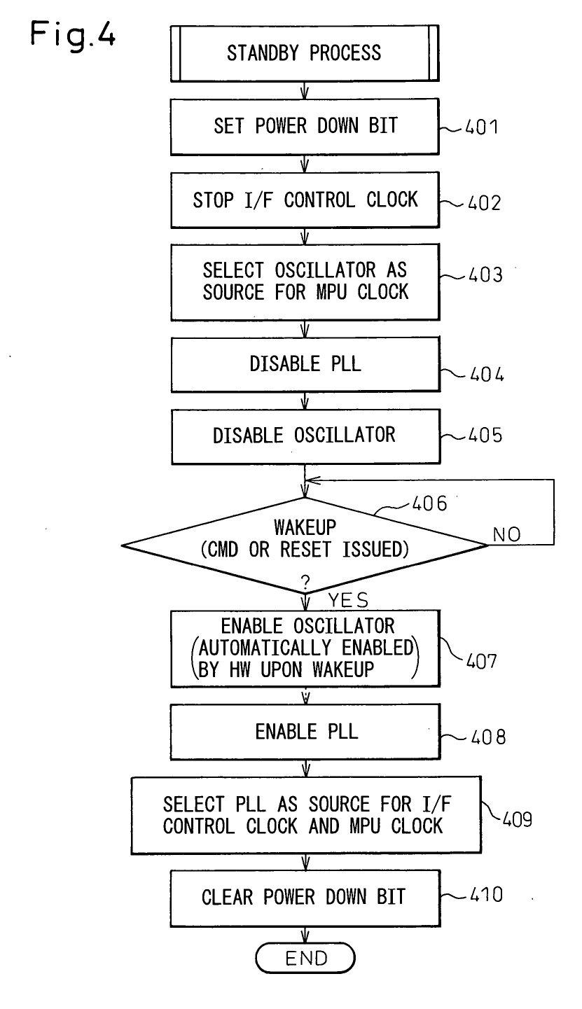

FIG. 4 is a flowchart illustrating a standby process according to the present invention. According to the standby process of the present invention shown in FIG. 4 in which the system is powered down but can receive a command from the host computer 2, since the I/F control clock can be stopped during standby, power consumption can be reduced to a level comparable to that in the prior art sleep mode by stopping the I/F control clock in the same manner that it is stopped in the prior art sleep process in which the system is powered down and does not accept any command from the host computer 2. The standby process of the present invention combines the prior art standby process and sleep process. The MPU 10 that received a command from the host computer 2 determines whether the command concerns the power-saving mode for which the standby process is to be performed or the normal power mode for which the standby process is not to be performed; when the command directs the standby process, the following flowchart is executed.

In the flowchart shown in FIG. 4, the power down bit is set in step 401. In step 402, the I/F control clock is stopped. In step 403, the oscillator 11 is selected as the source for the clock signal to the MPU 10. In step 404, the PLL 12 is disabled. In step 405, the oscillator 11 is disabled. Steps 404 and 405 are performed because the MPU 10 does not need the high-frequency clock signal from the oscillator 11 in the power-saving standby mode; during this period, the MPU 10 is supplied with a clock signal whose frequency is significantly lower than that of the clock generated by the oscillator 11.

In step 406, a decision is made as to whether the power supply is to be put in the power-saving mode or the wakeup mode and, if the result of the decision is the wakeup mode, the process proceeds to step 407; on the other hand, if the result of the decision is the power-saving mode, the process returns to step 406. In step 407, the oscillator is enabled.

In step 408, the PLL 12 is enabled. In step 409, the PLL 12 is selected as the source for the I/F control clock and also the source for the clock signal to the MPU 10. In step 410, the power down bit is reset, and the standby process is thus terminated.

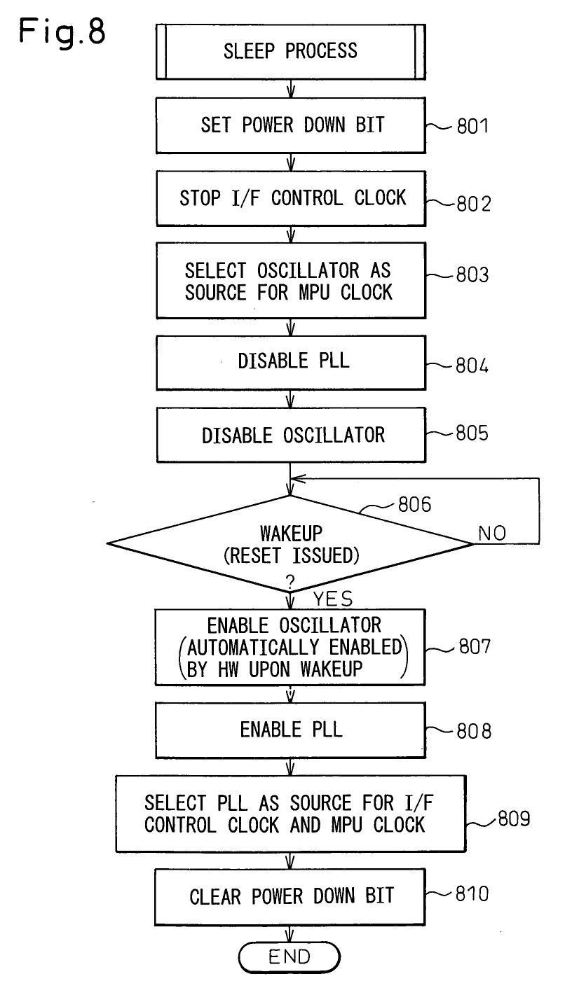

The flowchart of the present invention shown in FIG. 4 is substantially the same as the flowchart of the prior art shown in FIG. 8, the only difference being that, in the present invention, the wakeup in step 406 (step 806) is triggered when either a command or the reset signal is issued from the host computer 2, while in the prior art, it is triggered only by the reset signal.

The above embodiment of the present invention has been described by referring to an example in which the invention is applied to a digital circuit used by itself but, instead, the invention may be applied to a digital circuit that includes firmware. Further, the description has been given by taking a hard disk as the example of the external storage device, but other types of external storage device, such as CD-R, DVD-RW, or MO, may be used in the present invention.

What is claimed is:

1. An external storage control device which receives a command from a host system and transfers data to and from an external storage device, comprising:
a detecting section which detects a write command for writing data from said host system to a task file register in said external storage control device, when in a power-saving mode during which a clock from an oscillator is not supplied to said external storage control device; and
a latch section which stores said data in synchronism with said write command.

2. An external storage control device which receives a command from a host system and transfers data to and from an external storage device, comprising:
a first latch section which stores data received from said host system for writing to a task file register in said external storage control device, when in a normal power mode during which a clock is supplied from an oscillator to said external storage control device;
a second latch section which stores data received from said host system for writing to said task file register in said external storage control device, when in a power-saving mode during which the clock from said oscillator is not supplied to said external storage control device; and
a selecting section which selects the data to be written to said task file register in such a manner that, in said normal power mode, the data stored in said first latch section is written to said task file register and, in said power-saving mode, the data stored in said second latch section is written to said task file register.

3. An external storage control device as claimed in claim 1, further comprising a signal generating section which generates a signal for causing the data stored during said power-saving mode to be written to said task file register when clock operation is resumed by switching from said power-saving mode during which the clock from said oscillator is not supplied to said external storage control device back to said normal power mode during which the clock from said oscillator is supplied to said external storage control device.

4. An external storage control device as claimed in claim 2, further comprising a signal generating section which generates a signal for causing the data stored during said power-saving mode to be written to said task file register when clock operation is resumed by switching from said power-saving mode during which the clock from said oscillator is not supplied to said external storage control device back to said normal power mode during which the clock from said oscillator is supplied to said external storage control device.

5. An external storage control device as claimed in claim 3, wherein the data stored during said power-saving mode is written to said task file register when the output signal of said signal generating section is inverted.

6. An external storage control device as claimed in claim 4, wherein the data stored during said power-saving mode is written to said task file register when the output signal of said signal generating section is inverted.

7. A program for use in an external storage control device which receives a command from a host system and transfers data to and from an external storage device, said program causing a computer to execute the steps of:
setting a power-down bit for switching from a normal power mode during which a clock is supplied from an oscillator to said external storage control device to a power-saving mode during which said clock is not supplied;
stopping the supply of said clock from said oscillator to said external storage control device when said power-down bit is set;
when switching is made from said power-saving mode back to said normal power mode, then resetting said power-down bit and writing, to a task file register in said external storage control device, data that has been transferred from said host system for writing to said task file register and that has been held in a latch section while the supply of said clock to said external storage control device is stopped; and
resuming the supply of said clock from said oscillator to said external storage control device when switching has been made from said power-saving mode back to said normal power mode.
